(19) United States
(12) Patent Application Publication
(10) Pub. No.: US 2005/0158602 A1
(43) Pub. Date: Jul. 21, 2005

(54) Fuel cell, cell or group of cells belonging to said fuel cell, replacement kit for said fuel cell and method for making same

(76) Inventor: Thierry Novet, Bernin (FR)

Correspondence Address: Air Liquide;Intellectual Property Department, Ste. 1800, 2700 Post Oak Blvd, Houston, TX, 77056, US

(21) Appl. No.: 10/506,648

(22) PCT Filed: Mar. 3, 2003
(86) PCT No.: PCT/FR03/00672

(30) Foreign Application Priority Data
Mar. 6, 2002 (FR) 02/02843

(51) Int. Cl. H01M 8/10; H01M 8/02; H01M 2/08

(52) U.S. Cl. 429/32; 429/37; 429/38

(57) ABSTRACT

The invention concerns a fuel cell comprising a series of elementary cells (16₁ to 16ₙ), each of said elementary cells including a central structure (36₁) consisting of one membrane and of two electrodes, arranged on either side of said membrane, as well as separation means, for separating each elementary cell relative to the or to each adjacent cell. The invention is characterized in that at least two adjacent cells (16₁, 16₂, 16₃, 16ₙ) are provided with independent separation means (44₁, 42₂, 44₂, 42₃, 44ₙ₋₁, 42ₙ), particular to each of said two cells, such that said two adjacent cells can be disconnected from each other.

The present invention concerns the technical field of energy production based on a fuel cell battery and more particularly the architectures of fuel cell batteries.

Conventionally, a fuel cell battery comprises a succession of elementary cells, positioned beside each other in an assembly commonly called a “pack”. Each cell has an anode compartment where hydrogen oxidation takes place, as well as a cathode compartment in which oxygen from the air is reduced, with production of water. In addition, a proton exchange membrane (PEM) physically separates the anode and cathode compartments of a particular cell, which are also connected to an external electrical circuit.

The anode compartment is put into communication with a line introducing hydrogen, as well as a line for evacuating the hydrogen consumed. The latter is mixed with a water fraction that has been produced in the region of the cathode and has passed through the aforementioned separating membrane. Similarly, the cathode compartment is provided with a conduit introducing a gas mixture containing oxygen, typically air, and also a conduit for evacuating this oxygen-depleted mixture mixed with water.

In addition, several bipolar plates are generally provided, each of which separates two adjacent elementary cells. Such plates are capable of ensuring several functions, such as in particular the distribution of reactive gases.

The architecture of a fuel cell battery of the type described above exhibits certain disadvantages, in particular in terms of maintenance.

Indeed, when a cell of this battery of cells is damaged, it is necessary to dismantle the pack entirely and then to re-assemble the entire battery of cells. Moreover, it proves necessary to reject certain elements of the battery of cells, such as seals.

The present invention aims to remedy such disadvantages and proposes to produce a fuel cell battery with a simple and robust configuration, the maintenance of which is greatly facilitated.

To this end, the invention provides a fuel cell battery, more particularly comprising a series of elementary cells pressed against each other by compressive means, each of these cells having a central structure formed of a membrane and of two electrodes positioned either side of this membrane and, either side of the central structure, an outer separating structure, the cells being pressed with their separating structures in contact with each other, so that these two adjacent cells can be detached from each other by deactivating the compressive means, and means for introducing and evacuating fluids extending along the cells and that can be connected individually to the latter.

According to other features of the invention:
each of the introducing and evacuating means includes an extensible, typically telescopic, fluid distribution assembly;
each joining device is mounted in a support of the fuel cell battery, with the possibility of transverse clearance with respect to this support, at least along the longitudinal direction of the fuel cell battery;
at least one device is provided ensuring leakproofness between each joining device and a corresponding channel and resting against a sealing zone bordering this channel, said sealing zone being cylindrical with an axis parallel to a principal plane of the cell;
the or each fluid distribution assembly comprises at least two fluid distribution elements, positioned one behind the other in the direction of flow of each fluid, these elements being connected mutually by at least one intermediate connection, capable of sliding in relation to the distribution elements that it connects;
the or each fluid distribution assembly is made of an electrically insulating material and is advantageously made of a moldable material.

The invention also concerns an elementary cell, or a group of elementary cells, for a fuel cell battery such as defined above, the or each cell comprising at least one central structure formed of a membrane and of two electrodes, positioned either side of this membrane, as well as two separating devices provided at the two ends of the elementary cell or group of cells, each separating device being able to rest against another separating device belonging to an adjacent cell, in an arrangement making it possible in this way easily to detach the elementary cell or group of cells with respect to each adjacent cell without dismantling the entire battery of cells.

The invention also concerns a replacement kit for an elementary cell or a group of elementary cells such as defined above, comprising a central structure formed of a membrane and of two electrodes, positioned either side of this membrane, as well as a closed packaging in which the central structure is accommodated.

According to other features of the invention:
orifices are provided in a peripheral seal of the central structure, these orifices being able to receive the positioning means;
the packaging contains an inert gas, in particular nitrogen.

The invention finally concerns a process for manufacturing the replacement kit such as defined above, wherein the central structure is assembled by hot-pressing, and the packaging is added around this central structure.

According to another feature of the invention, before adding the packaging an electric preconditioning current is passed through the central structure.

The invention will be better understood on reading the following description of particular embodiments, given by way of non-limiting examples, made with reference to the accompanying drawings, in which:

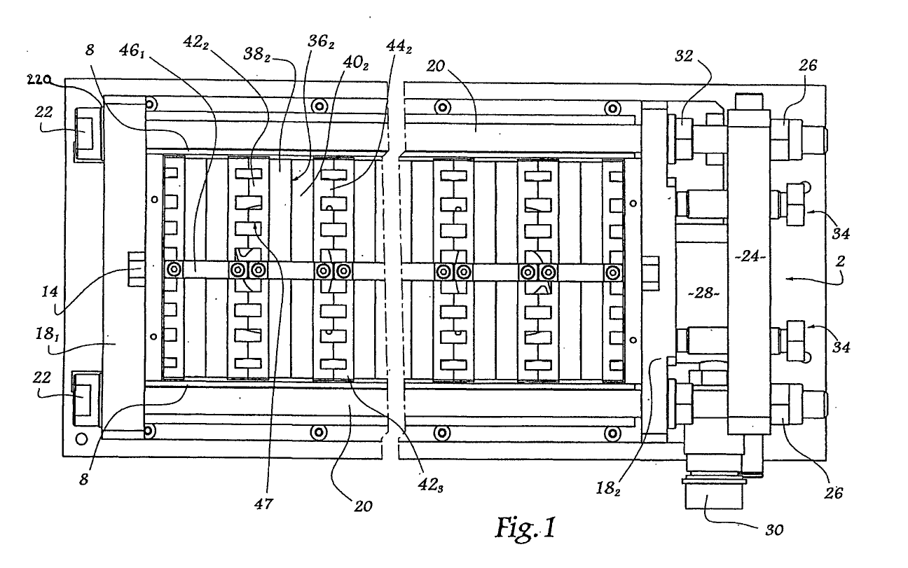

FIG. 1 is a view from above, illustrating one embodiment of a fuel cell battery according to the invention;

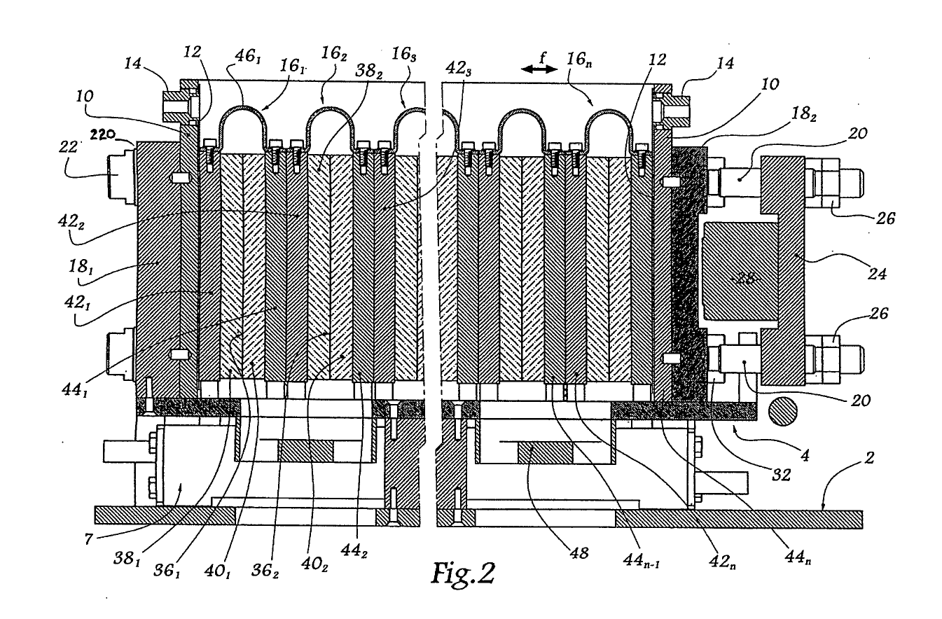

FIG. 2 is a view in longitudinal section of this battery of cells, along the line II-II of FIG. 1;

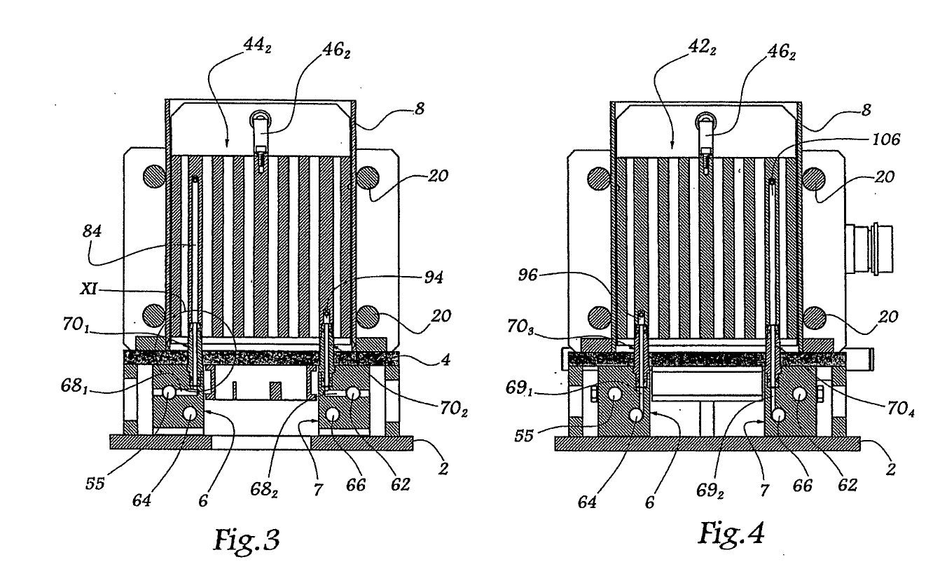

FIGS. 3 and 4 are cross-sectional views of this battery of cells, along the lines III-III and IV-IV respectively of FIG. 2;

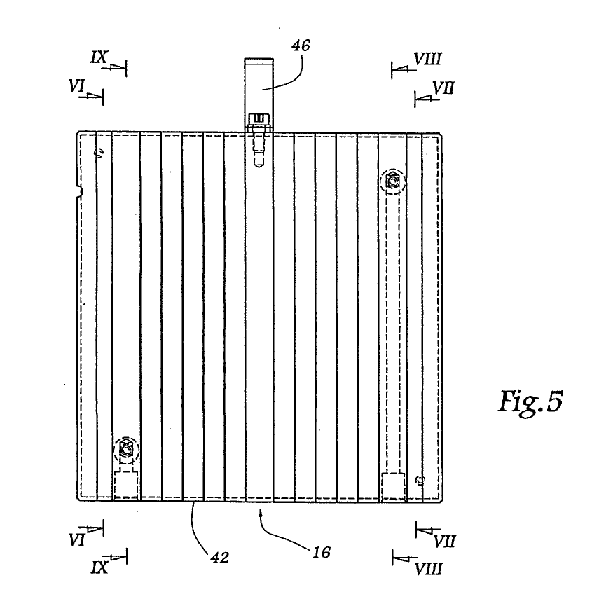

FIG. 5 is a front view illustrating an elementary cell of the fuel cell battery of FIGS. 1 to 4;

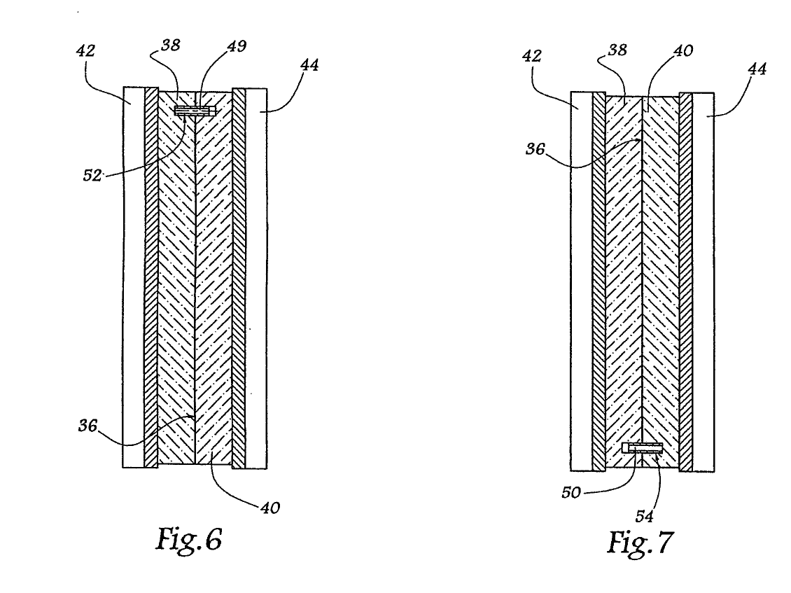

FIGS. 6 and 7 are cross-sectional views, along the lines VI-VI and VII-VII respectively of FIG. 5, illustrating the mounting of this elementary cell;

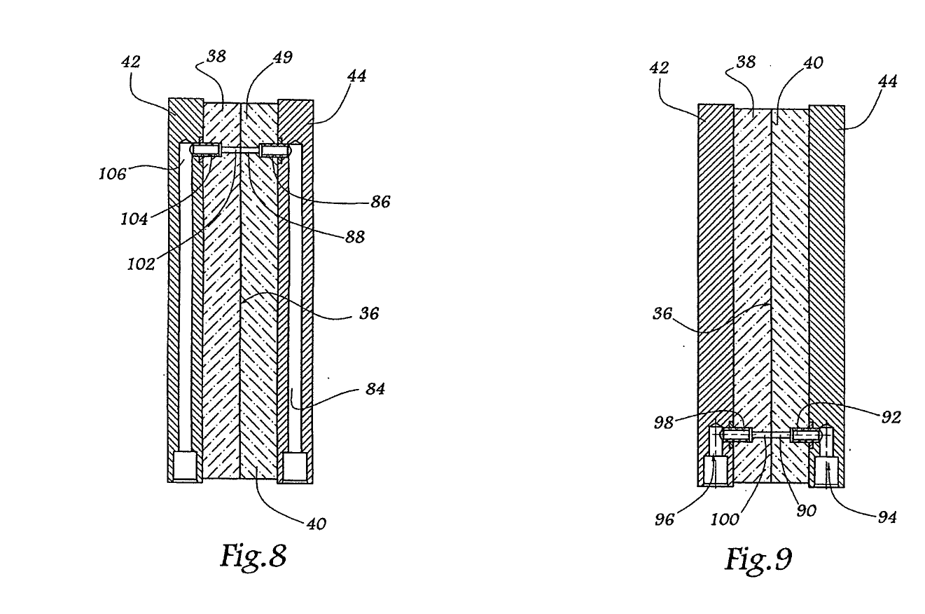

FIGS. 8 and 9 are cross-sectional views along the lines VIII-VIII and IX-IX respectively of FIG. 5, illustrating the circulation of gases inside this cell;

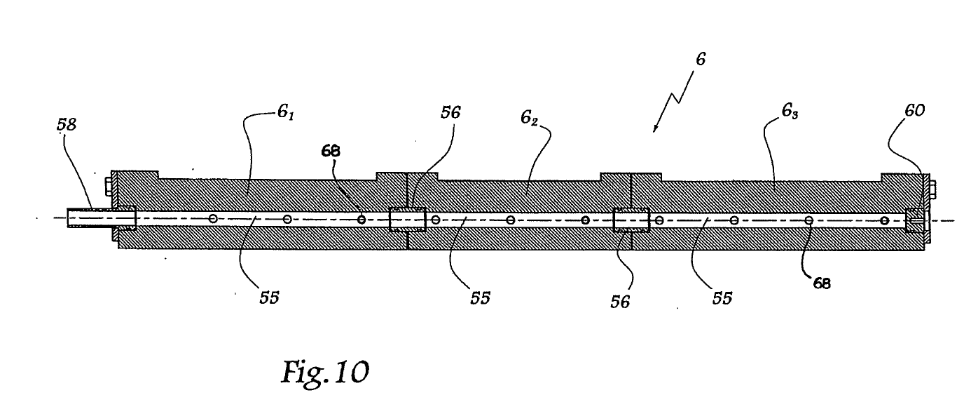

FIG. 10 is a view in longitudinal section, illustrating a distribution assembly for gases belonging to the fuel cell battery of FIGS. 1 to 4;

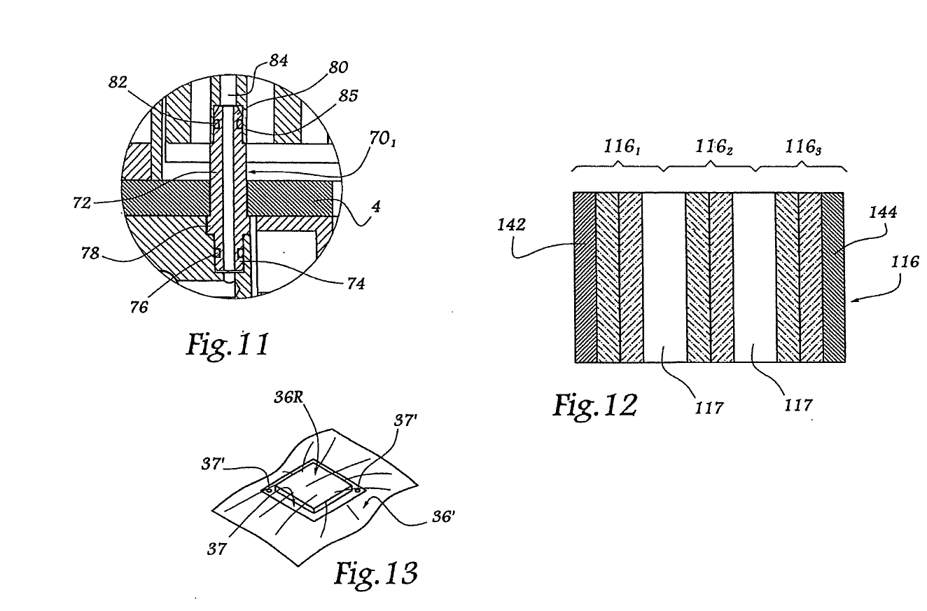

FIG. 11 is a view in longitudinal section, on an enlarged scale, illustrating a joining finger belonging to the fuel cell battery of FIGS. 1 to 4;

FIG. 12 is a diagrammatic view illustrating a group of elementary cells that can equip the fuel cell battery of FIGS. 1 to 4; and

FIG. 13 is a diagrammatic view in perspective, illustrating a replacement kit capable of cooperating with an elementary cell or a group of elementary cells for equipping the fuel cell battery of FIGS. 1 to 4.

In the embodiment shown in FIGS. 1 to 4, the fuel cell battery according to the invention comprises a base or supporting structure 2, typically in the form of a plate, above which there extends, parallel to the base, an intermediate platform or plate 4. Between these two elements, two gas distribution assemblies or manifolds are inserted, identified by references 6 and 7, which will be described below in greater detail.

The platform 4 is surmounted by two parallel vertical lateral walls 8, at the front end of which two parallel vertical insulating pieces 10 are positioned orthogonal to the walls 8. Conducting sheets 12, made for example of copper and linked to electrical terminals 14, are placed on the inner face of the insulating pieces 10.

A succession of elementary cells 16₁ to 16ₙ is interposed between the two conducting sheets 12. The structure of each of these cells will be described subsequently in greater detail.

Two vertical holding plates 18₁ and 18₂, designed to hold the assembly of elementary cells mechanically, are positioned against the outer face of the insulating pieces 10. In addition, four bars or stays 20 extend horizontally along the lateral walls 8, outside these.

Each bar 20 traverses the first holding plate 18₁ at a first end. It is secured there via a stop formed by a head 22, while a Belleville washer 220, not shown in detail, is interposed between this stop 22 and the opposite face of the plate 18₁.

In service, these washers 220 make it possible to absorb variations in length due to possible thermal expansions and guarantee maintenance of the assembly pressure.

At their other end, the bars 20 traverse the other holding plate 18₂ and are engaged in an auxiliary vertical plate 24, provided at a distance, outside the holding plate 18₂ parallel to the latter. The bars 20 are provided at their ends with a threaded portion, cooperating with an end assembly nut 26.

In the embodiment shown, a jack 28, advantageously hydraulic, provided with its supply pipework 30, is inserted between the holding plate 18₂ and the auxiliary plate 24. It should be noted that, in the vicinity of the holding plate 18₂, each bar 20 is advantageously provided with an intermediate threaded portion that can cooperate with a nut 32 for maintaining tension cooperating by resting against the outer face of the plate 18₂.

Finally, the auxiliary plate 24 receives four axial screws, only two 34 of which are shown. The ends of the stems of these screws are able to press against the outer face of the holding plate 18₂ so that these screws are, where appropriate, able to substitute for the jack 28.

Referring from now on in particular to FIG. 2, each elementary cell 16 includes a central lamellar structure 36, consisting of a sandwich of an electrode, a membrane and an electrode. This structure, known as such, is bordered peripherally by a seal 37, shown in FIG. 13. Each electrode can be structured so as to ensure directly the distribution of gases. It can also, as a variant, include a reaction zone, associated with a diffusion zone. The membrane is advantageously made of Nafion™ polymer, marketed by DuPont, the electrodes consisting of a porous structure made of platinized graphite, Nafion™ and PTFE, and the interstitial diffusion layers of graphite and PTFE.

In the embodiment shown, two intermediate plates 38 and 40, forming current collectors, are positioned either side of the central structure 36. As will be subsequently seen, the intermediate plate 38 is intended for the circulation of hydrogen, while the plate 40 is intended for the circulation of air. These plates 38, 40 are for example made of graphite or of a porous metallic material.

Finally, two separating plates 42 and 44 are placed either side of the plates 38 and 40. These end plates 42 and 44, that are dedicated to distributions of hydrogen and air respectively, are put into communication with an adjacent intermediate plate, as will subsequently be described. They are made for example of graphite, a graphite-polymer mixture or metal.

As shown in FIG. 2, in the embodiment shown, two adjacent cells, for example 16₂ and 16₃, are separated by means of the plates 44₂ and 42₃. It should be noted that such separating plates, that are independent, are specific to each of these two cells. In the case of the present fuel cell battery, the usual single bipolar plate is in fact replaced by these two distinct plates 42, 44, that can thus in fact be referred to as “monopolar”. This represents an appreciable advantage in terms of maintenance in as much as two adjacent elementary cells can be easily detached from each other with a view to demounting them. With such an arrangement, the thickness of each cell lies between approximately 8 and 10 mm.

As a variant, not shown, each plate 42 or 44 can be made in one piece with a corresponding intermediate plate 38 or 40, so as to form a single separating device. In this case, the overall thickness of the cell can be brought down to approximately 6 mm.

A loop or handle 46 is additionally provided, fixed at its ends onto the upper edges of the two separating plates 42 and 44 of the same elementary cell 16. Such a handle enables a user to grasp and handle this elementary cell, which makes demounting this cell particularly easy.

As shown in particular in FIG. 1, the opposite faces of the adjacent separating plates 42, 44 are indented or grooved, which leads to the formation of fins or ribs 47. The spaces between the latter are able to allow a flow of cooling air to circulate, coming from fans 48 advantageously positioned between the plates 4 and 2, directly in contact with these separating plates. Under these conditions, the heat exchange surface is incorporated in the elementary cells of the fuel cell battery.

It should be noted that the pitch and width of the fins are calculated so as to prevent opposite fins from mutually interleaving, during mounting or demounting. The heat exchange function, described above, can also be provided by another device, such as a corrugated metal sheet, a mesh or furthermore a porous metallic material.

As shown more particularly in FIGS. 6 and 7, each intermediate plate 38, 40 is provided with a corresponding pin 49, 50. The latter typically traverses the peripheral seal of the central structure 36, so as to be housed in an orifice 52, 54, provided opposite in the other intermediate plate 40, 38. These pins 49, 50 not only ensure against mistakes in assembling the cell, but also ensure the holding and positioning of all the preassembled cell, in the absence of other fixing means.

As a variant, all the elementary cells of the fuel cell battery need not be individual, in this sense a subassembly of these cells is able to form an indissociable group, given the reference 116 in FIG. 12. From this point of view, such a group 116 of cells is provided with one or more bipolar separating plates, made in a known manner. In the example described with reference to FIG. 12, three cells 116₁ to 116₃ are provided, separated pairwise by two bipolar plates 117.

Only the end separating plates 142 and 144 of this group of cells are then individual, that is to say they are for example similar to cells 42 and 44 of the figures. In this way, this group of cells 116 is detachable in a block in relation to the cells that are adjacent thereto, not shown in this FIG. 12.

As a supplementary variant, it is advantageous to provide, in a separate manner, supplementary cells or groups of cells, that can be substituted for any cells which might be damaged. In this respect, it is more particularly advantageous to place and store these replacement cells or groups of cells in an individual package, for example in cellophane packaging.

FIG. 10 illustrates one (6) of the gas distribution assemblies mentioned above, it being understood that the other (7) of these assemblies, outlined in FIG. 1, possesses a similar structure.

In the example shown, the assembly 6 is composed of three aligned distribution elements 6₁ to 6₃, each drilled with an axial through-hole drilling 55, these drillholes communicating with each other. These elements are additionally linked two-by-two by intermediate annular connections 56 inserted in end zones of widened diameter of the drillholes 55. Each connection, which is provided with two peripheral O-ring seals, is capable of sliding with respect to the two elements that it connects. In this way, it provides a telescopic attachment between these two elements. This therefore makes it possible to absorb variations in the length of the battery of cells due to it being put under pressure, with a view to its assembly, or furthermore due to thermal expansions in operation.

One (6₁) of the distribution elements is additionally provided at its outer end with a connection 58, designed to be connected to an air inlet. This connection 58, provided with a peripheral seal, and accommodated in one end with a widened diameter of the drillhole 55 of the element 6₁, is also capable of sliding with respect to this element 6₁. Finally, the other end element 6₃ is equipped with a stopper 60, designed to prevent any premature loss of air.

Advantageously, at least one of the distribution assemblies 6, 7 is made of an electrically insulating material, for example polyamide or polypropylene. Accordingly, water which is evacuated by this distribution assembly is not in contact with the electrical components of the cells. This consequently provides excellent insulation to the power circuit. Advantageously, each fluid distribution assembly is made of a moldable material, which makes it possible to establish mass production, and thus to reduce the corresponding costs.

As shown in FIGS. 3 and 4, four series of parallel drillholes are provided in the gas distribution assemblies 6 and 7. Accordingly, apart from the axial drillholes 55, intended as air inlet, axial drillholes 62 intended as air outlet, and axial drillholes 64 intended as hydrogen inlet, as well as axial drillholes 66, intended as outlet for this hydrogen, are provided.

Attention will now be given more particularly to FIG. 3 which illustrates the separating plate 44₂ dedicated to air circulation. As shown in this FIG. 3, the drillhole 55, intended as air inlet, communicates with a horizontal transverse passage 68₁ which itself emerges in a vertical inner volume receiving a joining finger 70₁ vertically traversing the plate 4 with a possibility of transverse clearance, at least from the back to the front of the battery of cells (arrow f in FIG. 2). Given that the upper end of this finger 70₁ is intended, in service, to be secured to the plate 44₂, this clearance makes it possible to compensate for variations in the length of the battery of cells when put under pressure.

With reference to FIG. 11, which illustrates on a larger scale the finger 70₁, the latter comprises a tubular body 72, ending in a lower chamfered end 74, provided with a peripheral seal 76, accommodated in the vertical volume of the block of the distribution assembly 6. The body 72 is additionally provided with a collar 78, capable of cooperating with the lower face of the plate 4, so as to hold all the finger in position, against a force exerted upwards. Finally, this finger 70₁ possesses a chamfered upper end 80, provided with a peripheral seal 82, inserted in service, in the walls of an inner distribution channel 84, extending vertically in the separating plate 44₂.

More precisely, the peripheral seal 82 rests against a sealing zone 85, bordering the channel 84. This sealing zone 85 possesses a cylindrical shape of which the cross-section, circular in the example shown, may be of any type. In addition, the principal axis of the cylinder forming the zone 85 is parallel to the principal plane of the cell, namely it is vertical in FIG. 11.

It should be noted that the two ends 74 and 80 of the finger 70₁ also enable it to absorb variations in length of the battery of cells while guaranteeing leakproofness by virtue of the two O-ring seals 76, 82. As an alternative, the two ends of the joining finger 70 can be made of a material allowing such a clearance. Reference will in particular be made, in a non-limiting manner, to an elastomeric material.

As shown in FIG. 8, the channel 84 emerges, via a connection 86, in a first end 88 of an air distribution network, provided in a conventional manner in the intermediate plate 40 forming a current collector. This network, of which only the inlet and outlet are shown in FIGS. 8 and 9, extends to the vicinity of the central structure 36, so as to make it possible to carry out the reduction reaction of the oxygen of the air, in the cathode compartment of the cell. As shown in FIG. 9, this air distribution network ends, in the intermediate plate 40, in another end 90 which emerges, via a tubular connection 92, in a channel 94 for the evacuation of air, provided in the lower end of the separating plate 44. The walls of this channel 94 receive another joining finger 70₂ similar to that 70₁ previously described. This finger 70₂ connects the channel 94 to a supplementary horizontal transverse passage 68₂ that emerges in the air outlet axial drillhole 62, provided in the gas distribution assembly 7.

Referring from now on to FIG. 4, the drillhole 64 for introducing hydrogen is put into communication with a vertical transverse passage 69₁ which emerges in the inner volume of a joining finger 70₃ similar to those 70₁ and 70₂ previously described. The downstream end, namely the upper end in FIG. 4, of this finger 70₃ emerges in a vertical channel 96, formed in the plate 42₂, belonging to the same elementary cell 16₃ as the plate 44₂. As shown in FIG. 9, this channel 96 is put into communication, via a tubular connection 98, with an end 100 of a hydrogen distribution network similar, in its architecture, to the air distribution network described above.

This hydrogen network, which is provided in the intermediate plate 38, extends opposite, with respect to the central structure 36, to the air distribution network previously described. Such a distribution network is intended for carrying out the reaction of hydrogen oxidation in the anode compartment of the cell.

As shown in FIG. 8, the other end 102 of this hydrogen distribution network is put into communication, via a tubular connection 104, with a channel 106 for evacuating hydrogen, provided in the separating plate 44₂ (see also FIG. 4). The lower end of this channel 106 receives the upper end of a joining finger 70₄, similar to those described previously. This finger 70₄ in this way puts the channel 106 into communication with a vertical passage 69₂, provided in the distribution assembly 7 and then emerging in the axial drillhole 66, allowing hydrogen to leave.

As a variant, the addition may be envisaged of supplementary connections that would be linked to the fluid distribution assemblies 6 and 7. Such connections, dedicated for example to the circulation of a cooling fluid, are capable of supplying a circuit that would then be integrated into the separating plates 42 and 44. Such a cooling circuit would thus substitute for air cooling, guaranteed by the fins 47.

Putting the different elementary cells of the fuel cell battery under compression, described with reference to the preceding figures, is carried out as follows:

The necessary assembly pressure should first of all be ensured. This phase is carried out by means of the jack 28, that can where appropriate be associated with the screws 34 or be replaced by these.

The lock nuts 32 are then screwed, for example manually, against the holding plate 18₂, so as to hold the latter in position pressed flat against the pack of cells. This also helps to keep the compression exerted on the assembly of cells constant. It should moreover be noted that the plates 18₁ and 18₂ enable this compression to be made uniform.

Once this operation has been carried out, it is then possible to release the action exerted by the jack 28, and, where appropriate, by the screws 34. The fuel cell battery is then in a normal functioning configuration.

It should be noted that, in service, the compression exerted on the assembly of cells ensures electrical contact and therefore the passage of current between the various cells via the separating plates 44.

If it is desired to release the assembly pressure exerted on the various cells, a temporary pressure slightly greater than this assembly pressure is first of all applied by the jack 28 and where appropriate the screws 34. This makes it possible to free and unscrew the lock nuts 32. The action of the jack 28 and the screws 38 is then stopped. Once these operations have been carried out successfully, the different elementary cells 16 of the fuel cell battery are no longer subjected to any mechanical pressure. In this way, they are no longer secured to each other.

It can thus be imagined that it is then possible to withdraw one or other of these elementary cells transversely, for example with a view to their maintenance or replacement without dismantling the rest of the pack of cells. With this in mind, a supplementary substitution cell can easily be positioned in place of the cell that has been lifted out.

As a variant, provision can be made not to use a Belleville washer or other added elements forming a spring. With this in mind, the holding plate 18₁ is then formed in order to obtain a prestress, so that it ensures at the same time the functions of making the compression uniform and of holding this compression.

FIG. 13 illustrates, according to one aspect of the invention, a replacement kit for an elementary cell 16 or group of elementary cells 116.

This kit comprises a central replacement sandwich structure 36R, similar to that previously described. This central structure 36R is provided in a known manner, with a flat peripheral seal 37 bordering the membrane and electrodes. Two orifices 37′ are provided in this seal 37, for example symmetrically with respect to the center of gravity of all the structure. Such orifices are able to receive the pins 49, 50 described with reference to FIGS. 6 and 7. The sandwich structure presents a variable surface area, typically with a format comprised between 12 and 15 cm and an A₄ format.

In addition, the replacement kit includes a packaging 36′ in which the structure 36R is received in a leakproof manner. Such a packaging is for example made of cellophane or polyurethane. Advantageously, this package encloses an inert gas such as nitrogen.

The process for manufacturing the replacement kit of FIG. 13 first of all includes a phase for assembling the central sandwich structure 36R. This is carried out in a known manner by hot-pressing, for example at a temperature of between 80 and 90° C. and at a pressure close to 20 bar.

Advantageously, before confining the structure 36R by means of the packaging 36′, this central structure is validated by submitting the latter to a conditioning current, of which the value is for example between 0.4 and 0.6 A/cm². Such a measure makes it possible to guarantee and optimize subsequent performances of the central replacement structure once the latter is installed in an elementary cell.

When one of the cells 16₁ to 16ₙ of the fuel cell battery is damaged in the region of its central structure, for example in the case of tearing of its membrane, it is possible to withdraw this cell individually, as previously described. Then, instead of replacing all the cell, it is possible only to change the central structure, the intermediate plates and separating plates not then being rejected. This is most particularly advantageous since it is possible to provide, on site, a reserve of a certain number of replacement kits, such as that of FIG. 13, in order to make possible substitutions. It can be easily be imagined that such replacement kits have a particularly reduced overall size.

Although the invention has been described in relation to particular embodiments, it is not limited to these but is capable of adaptations and variants that will be apparent to a person skilled in the art within the framework of the following claims.

1-26. (canceled)

27: An apparatus which may be used as a fuel cell battery comprising:
a) a series of elementary cells pressed against each other by a compressive means, wherein said cells comprise;
1) a central structure, wherein said central structure comprises;
i) a membrane; and
ii) two electrodes located on either side of said membrane;
2) an outer separating structure, located on either side of said central structure;
b) a compressive means to press said cells together, wherein
1) activating said compressive means compresses said cells such that said separating structures of adjacent cells are in contact with each other; and
2) deactivating said compressive means decompresses said cells such that said adjacent cells may be detached from each other; and
c) a fluid introduction and evacuation means, wherein said fluid means;
1) extends along said cells; and
2) can be connected individually to said cells.

28: The apparatus of claim 27, wherein said fluid means comprises an extendable fluid distribution assembly.

29: The apparatus of claim 28, wherein said fluid means further comprises at least two fluid distribution elements, wherein:
a) said distribution elements are positioned next to each other in the direction of flow of each fluid; and
b) said distribution elements are connected together by at least one intermediate connection, wherein said intermediate connection is capable of sliding in relation to the distribution elements it connects.

30: The apparatus of claim 29, wherein each said fluid means comprises an electrically insulating material.

31: The apparatus of claim 29, wherein each said fluid means comprises a moldable material.

32: The apparatus of claim 27, wherein each said cell is connected to each said fluid means by a corresponding joining device.

33: The apparatus of claim 32, wherein each said joining device is hollow and connects to a passage which connects to the corresponding said fluid means.

34: The apparatus of claim 33, wherein each said joining device connects to a corresponding channel, wherein said channel is connected to said cell.

35: The apparatus of claim 34, wherein said channel comprises at least one member selected from the group consisting of:
a) a fluid inlet channel; and
b) a fluid outlet channel.

36: The apparatus of claim 34, wherein each said joining device is mounted on a support of said apparatus and wherein there is traverse clearance, with respect to said support, in the longitudinal direction of said group of cells.

37: The apparatus of claim 36, wherein each said joining device comprises a holding device, and wherein each said holding device is located against the lower face of said support.

38: The apparatus of claim 34, further comprising at least one leak proofing means, wherein:
a) said leak proofing means ensures leak-proofness between each said joining device and each said corresponding channel; and
b) said leak proofing means is located against a sealing zone, wherein said sealing zone is located adjacent to each said corresponding channel.

39: The apparatus of claim 34, further comprising a means for applying uniform compression to said cells.

40: The apparatus of claim 39, wherein said uniform compression means comprises:
a) a first and a second end plate;
b) an auxiliary plate located at a distance form said second end plate;
c) at least one tensioning device located between said auxiliary plate and said second end plate; and
d) a connecting means to connect said auxiliary plate and said first end plate.

41: The apparatus of claim 40, wherein said tensioning device comprises at least one member selected from the group consisting of:
a) a hydraulic device;
b) a pneumatic device; and
c) a jack device.

42: The apparatus of claim 40, wherein said connecting means comprises at least two bars extending along said cells, and wherein each said bar passes through said first end plate, said second end plate, and said auxiliary plate.

43: The apparatus of claim 39, further comprising a means for maintaining the compression applied to said cells.

44: The apparatus of claim 43, wherein said compression maintaining means comprises at least one nut located on said bar, wherein said nut is capable of being positioned against at least one member selected from the group consisting of:
a) said first end plate; and
b) said second end plate.

45: An apparatus, which may be used in a fuel cell battery, comprising a group of elementary cells, wherein each cell of said group comprises:
a) at least one central structure, wherein said central structure comprises:
1) a membrane; and
2) two electrodes, wherein said electrodes are located on either side of said membrane; and
b) two separating devices located at the ends of said cells, wherein each separating device is located so as to rest against the separating device of an adjacent cell.

46: The apparatus of claim 45, wherein said cell further comprises a grasping means.

47: The apparatus of claim 46, wherein said grasping means comprises a loop.

48: The apparatus of claim 46, wherein said grasping means are attached to said separating devices.

49: The apparatus of claim 45, further composing a means for initially positioning said cells within said apparatus.

50: An apparatus which maybe used as a replacement kit for a group of elementary cells, wherein:
a) each cell of said group comprises:
1) at least one central structure, wherein said central structure comprises:
i) a membrane; and
ii) two electrodes, wherein said electrodes are located on either side of said membrane; and
2) two separating devices located at the ends of said cells, wherein each separating device is located so as to rest against the separating device of an adjacent cell; and
b) said apparatus comprises:
1) a kit central structure, wherein said kit central structure comprises:
i) a kit membrane; and
ii) two kit electrodes, wherein said kit electrodes are located on either side of said kit membrane; and
2) a closed packaging, wherein said packaging accommodates said kit central structure.

51: The apparatus of claim 50, further comprising orifices in a peripheral seal of said kit central structure, wherein said orifices are situated so as to receive a means for initially positioning said kit in said group of cells.

52: The apparatus of claim 50, wherein said packaging further comprises an inert gas.

53: A method which maybe used for manufacturing a replacement kit for a group of elementary cells, wherein:
a) each cell of said group comprises:
1) at least one central structure, wherein said central structure comprises:
i) a membrane; and
ii) two electrodes, wherein said electrodes are located on either side of said membrane; and
2) two separating devices located at the ends of said cells, wherein each separating device is located so as to rest against the separating device of an adjacent cell;
b) said apparatus comprises:
1) a kit central structure, wherein said kit central structure comprises:
i) a kit membrane; and
ii) two kit electrodes, wherein said kit electrodes are located on either side of said kit membrane;
2) a closed packaging, wherein said packaging accommodates said kit central structure; and
c) said method for manufacturing comprises:
1) assembling said kit central structure by hot-pressing; and
2) adding said packaging around said kit central structure.

54: The method of claim 53, further comprising passing a conditioning current through said kit central structure prior to the addition of said packaging.
